(19) United States
(12) Patent Application Publication
(10) Pub. No.: US 2008/0130116 A1
(43) Pub. Date: Jun. 5, 2008

(54) OPTICAL PLATE HAVING THREE LAYERS AND BACKLIGHT MODULE WITH SAME

(75) Inventors: Tung-Ming Hsu, Tu-Cheng (TW); Shao-Han Chang, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/671,651

(22) Filed: Feb. 6, 2007

(30) Foreign Application Priority Data
Dec. 1, 2006 (CN) 200610201192.8

(51) Int. Cl. G02B 5/02

(52) U.S. Cl. 359/599; 359/831

(57) ABSTRACT

An exemplary optical plate (20) includes a first transparent layer (21), a second transparent layer (23) and a light diffusion layer (22). The first transparent layer includes an outer surface (210) and a plurality of spherical protrusions (211) protruding out from the outer surface. The second transparent layer includes an outer surface (230) and a plurality of micro protrusions (231) protruding out from the outer surface. The light diffusion layer is integrally formed with the first and second transparent layers and is between the first and second transparent layers. The light diffusion layer includes a transparent matrix resin (221) and a plurality of diffusion particles (222) dispersed in the transparent matrix resin. An exemplary backlight module (200) employing the optical plate is also provided.

### CROSS-REFERENCE TO RELATED APPLICATIONS

This application is related to U.S. patent application Ser. No. 11/627,579 filed on Jan. 26, 2007 and entitled “OPTICAL PLATE HAVING THREE LAYERS” and U.S. patent application Ser. No. 11/620,958 filed on Jan. 8, 2007 and entitled “OPTICAL PLATE HAVING THREE LAYERS AND MICRO PROTRUSIONS”, both of which have the same applicant and assignee as the present invention.

### BACKGROUND OF THE INVENTION

1. Field of the Invention

The present invention to an optical plate for use in, for example, a backlight module, the backlight module typically being employed in a liquid crystal display (LCD).

2. Discussion of the Related Art

The lightness and slimness of LCD panels make them suitable for a wide variety of uses in electronic devices such as personal digital assistants (PDAs), mobile phones, portable personal computers, and other electronic appliances. Liquid crystal is a substance that cannot emit light by itself; instead, the liquid crystal relies on receiving light from a light source in order to display images and data. In the case of a typical LCD panel, a backlight module powered by electricity supplies the needed light.

FIG. 10 is an exploded, side cross-sectional view of a typical direct type backlight module 10 employing a typical light diffusion plate. The backlight module 10 includes a housing 11, a plurality of lamps 12 disposed on a base of the housing 11, and a light diffusion plate 13 and a prism sheet 15 stacked on top of the housing 11 in that order. The lamps 12 emit light rays, and inside walls of the housing 11 are configured for reflecting some of the light rays toward the light diffusion plate 13. The light diffusion plate 13 includes a plurality of dispersion particles. The dispersion particles are configured for scattering received light rays and thereby enhancing the uniformity of light rays that exit the light diffusion plate 13. The prism sheet 15 includes a plurality of V-shaped structures on a top thereof. The V-shaped structures are configured for collimating received light rays to a certain extent.

In use, the light rays from the lamps 12 enter the prism sheet 15 after being scattered in the diffusion plate 13. The light rays are refracted by the V-shaped structures of the prism sheet 15 and are thereby concentrated so as to increase brightness of light illumination. Finally, the light rays propagate into an LCD panel (not shown) disposed above the prism sheet 15. Even though the diffusion plate 13 and the prism sheet 15 are in contact with each other, a plurality of air pockets still exist at the boundary therebetween. When the backlight module 10 is in use, light passes through the air pockets, and some of the light undergoes total reflection at one or another of the corresponding boundaries. As a result, the light energy utilization ratio of the backlight module 10 is reduced.

Therefore, a new optical means is desired in order to overcome the above-described shortcomings. A backlight module utilizing such means is also desired.

### SUMMARY

An exemplary optical plate includes a first transparent layer, a second transparent layer and a light diffusion layer. The light diffusion layer is between the first transparent layer and the second transparent layer. The light diffusion layer includes a transparent matrix resin and a plurality of diffusion particles dispersed in the transparent matrix resin. The first transparent layer, the light diffusion layer, and the second transparent layer are integrally formed, with the first transparent layer in immediate contact with the light diffusion layer, and the second transparent layer in immediate contact with the light diffusion layer. The first transparent layer has a plurality of spherical protrusions protruding from an outer surface thereof distalmost from the light diffusion layer. The second transparent layer has a plurality of micro protrusions protruding out from an outer surface thereof distalmost from the light diffusion layer.

An exemplary direct type backlight module includes a housing, a plurality of light sources, and an above-described optical plate. The light sources are disposed on or above a base of the housing. The optical plate is disposed above the light sources at a top of the housing.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout the several views, and all the views are schematic.

FIG. 1 is an isometric view of an optical plate in accordance with a first embodiment of the present invention.

FIG. 2 is a cross-sectional view of the optical plate of FIG. 1, taken along line II-II thereof.

FIG. 3 is a cross-sectional view of the optical plate of FIG. 1, taken along line III-III thereof.

FIG. 4 is an isometric view of the optical plate of FIG. 1, showing the optical plate inverted.

FIG. 5 is a side cross-sectional view of a direct type backlight module in accordance with a preferred embodiment of the present invention, the backlight module including the optical plate of FIG. 1.

FIG. 6 is an isometric view of an optical plate in accordance with a second embodiment of the present invention.

FIG. 7 is an isometric view of an optical plate in accordance with a third embodiment of the present invention.

FIG. 8 is a side cross-sectional view of an optical plate in accordance with a fourth embodiment of the present invention.

FIG. 9 is a top plan view of an optical plate in accordance with a fifth embodiment of the present invention.

FIG. 10 is an exploded, side cross-sectional view of a conventional backlight module.

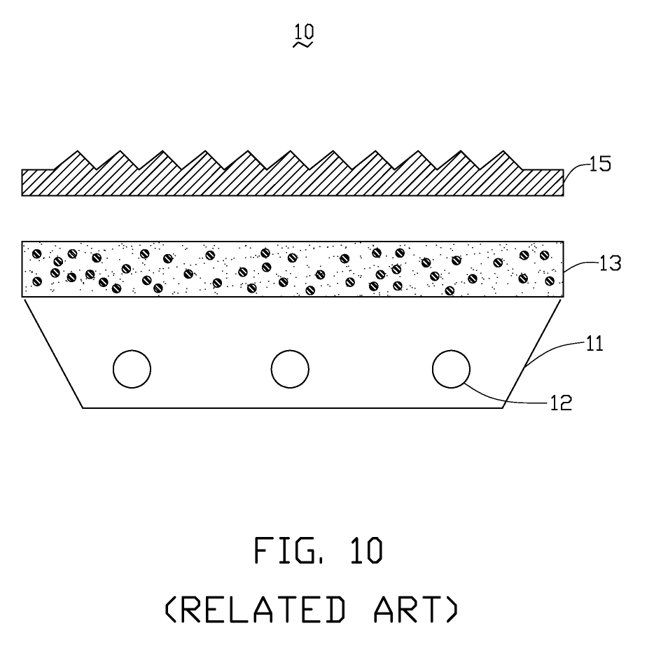

### DETAILED DESCRIPTION OF THE EMBODIMENTS

Reference will now be made to the drawings to describe preferred embodiments of the present optical plate and backlight module, in detail.

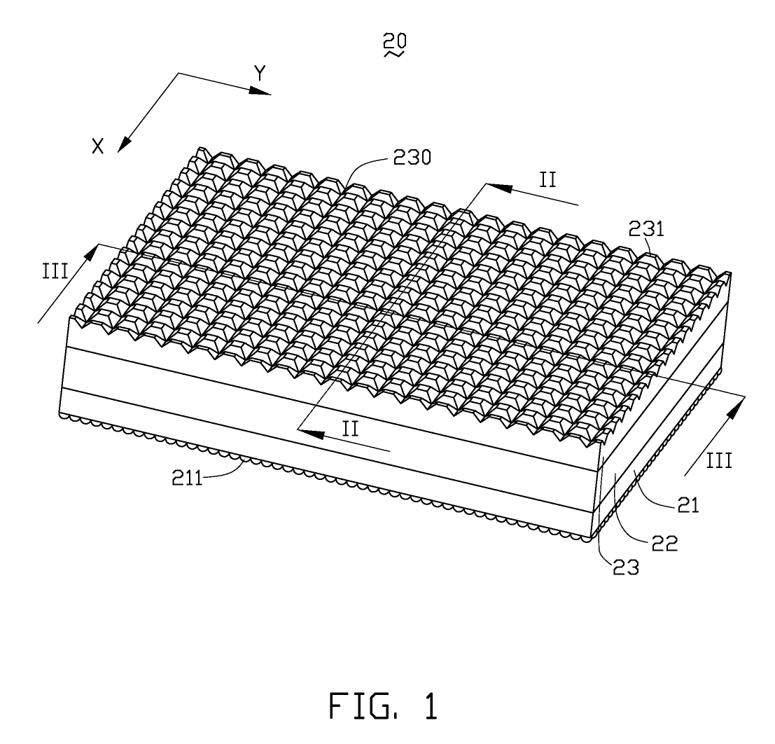

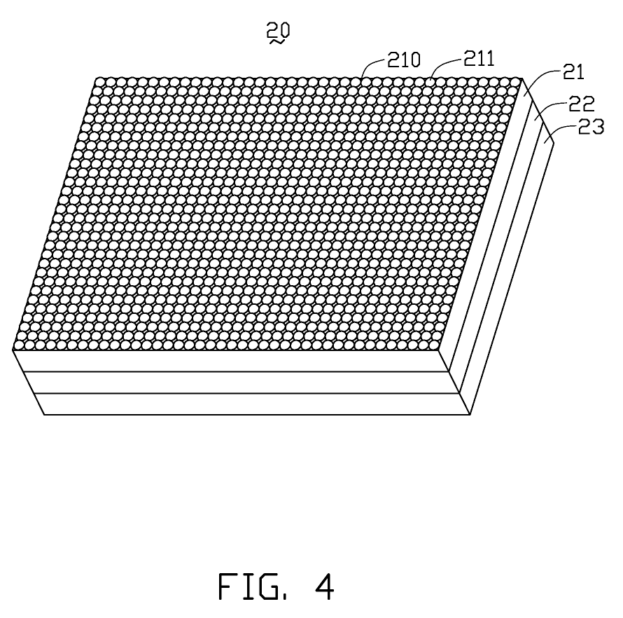

Referring to FIG. 1 through FIG. 4, an optical plate 20 according to a first embodiment of the present invention is shown. The optical plate 20 is generally rectangular, and includes a first transparent layer 21, a light diffusion layer 22, and a second transparent layer 23. The light diffusion layer 22 is between the first and second transparent layers 21, 23. The first transparent layer 21, the light diffusion layer 22, and the second transparent layer 23 are integrally formed by multi-shot injection molding technology. That is, the first transparent layer 21 and the light diffusion layer 22 are in immediate contact with each other at a common interface thereof, and the second transparent layer 23 and the light diffusion layer 22 are in immediate contact with each other at a common interface thereof. The first transparent layer 21 includes a plurality of spherical protrusions 211 protruding from an outer surface 210 thereof that is distalmost from the light diffusion layer 22. The second transparent layer 23 defines a plurality of micro protrusions 231 protruding from an outer surface 230 thereof that is distalmost from the light diffusion layer 22. Each of the micro protrusions 231 includes at least three side surfaces connected to each other. A horizontal width of each side surface decreases along a direction away from the light diffusion layer 22. The micro protrusions 231 are configured for cooperatively collimating to a certain extent light rays emitted from the second transparent layer 23, and thereby improving brightness of light illumination provided by the optical plate 20.

A thickness of each of the first transparent layer 21, the light diffusion layer 22, and the second transparent layer 23 may be greater than or equal to 0.35 millimeters (mm). In a preferred embodiment, a combined thickness of the first transparent layer 21, the light diffusion layer 22, and the second transparent layer 23 is the range from about 1.05 mm to about 6 mm. The first and second transparent layers 21, 23 can be made of transparent matrix resin selected from the group including polyacrylic acid (PAA), polycarbonate (PC), polystyrene (PS), polymethyl methacrylate (PMMA), methylmethacrylate and styrene (MS), and any suitable combination thereof. It should be noted that the material of the first and second transparent layers 21, 23 may be the same or different.

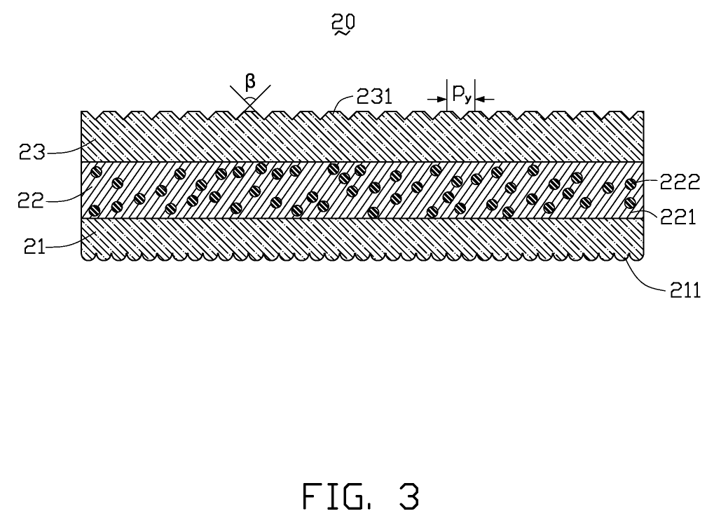

Referring to FIG. 3, in this embodiment, each spherical protrusion 211 is substantially a hemisphere. The spherical protrusions 211 are arranged regularly on the outer surface 210 in a matrix. That is, in one aspect, the spherical protrusions 211 are arranged in columns parallel to an X-axis of the optical plate 20 (as shown in FIG. 3). In another aspect, the spherical protrusions 211 are arranged in rows parallel to a Y-axis of the optical plate 20 (as shown in FIG. 3), the Y-axis being perpendicular to the X-axis. A pitch d between two adjacent spherical protrusions 211 is in the range from about 0.025 mm to about 1.5 mm. A radius R of each of the spherical protrusions 211 is in the range from about a quarter of the pitch d to about twice the pitch d. A height H of each of the spherical protrusions 211 is in the range from about 0.01 mm to about the radius R.

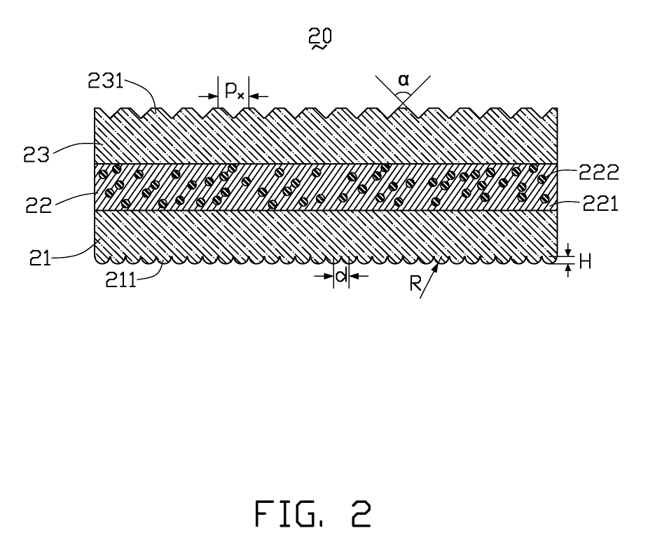

In this embodiment, the micro protrusions 231 are arranged regularly on the outer surface 230 in a matrix. Each micro protrusion 231 is generally frusto-pyramidal, and includes four side surfaces (not labeled). In the illustrated embodiment, each micro protrusion 231 is a pyramidal-like frustum. Each of the side surfaces of the micro protrusion 231 is an isosceles trapezium. Pₓ represents a pitch between two adjacent micro protrusions 231 aligned along the X-axis, as shown in FIG. 2. P_{y} represents a pitch between two adjacent micro protrusions 231 aligned along the Y-axis, as shown in FIG. 3. Each of Pₓ and P_{y} is configured to be in the range from about 0.025 mm to about 1.000 mm. Pₓ and Py can be equal to each other or different from each other. In the illustrated embodiment, Pₓ is less than P_{y}. Referring to FIGS. 1 and 2, an angle α is an imaginary dihedral angle defined by two symmetrically opposite side surfaces of each micro protrusion 231, which side surfaces are parallel to the Y-axis. Referring to FIGS. 1 and 3, an angle β is an imaginary dihedral angle defined by two other symmetrically opposite side surfaces of each micro protrusion 231, which side surfaces are parallel to the X-axis. Each of the angles α and β is configured to be in the range from about 60 degrees to about 120 degrees. The angles α, β can be equal to each other or different from each other. In the illustrated embodiment, the angle α is equal to the angle β.

The light diffusion layer 22 includes a transparent matrix resin 221, and a plurality of diffusion particles 222 dispersed in the transparent matrix resin 221. The transparent matrix resin 221 can be made of material(s) selected from the group including polyacrylic acid (PAA), polycarbonate (PC), polystyrene (PS), polymethyl methacrylate (PMMA), methylmethacrylate and styrene (MS), and any suitable combination thereof. The diffusion particles 222 can be made of material(s) selected from the group including titanium dioxide, silicon dioxide, acrylic resin, and any suitable combination thereof. The diffusion particles 222 are configured for scattering light rays and enhancing a uniformity of light exiting the light diffusion layer 22. The light diffusion layer 22 preferably has a light transmission ratio in a range from 30% to 98%. The light transmission ratio of the light diffusion layer 22 is determined by a composition of the transparent matrix resin 221 and the diffusion particles 222.

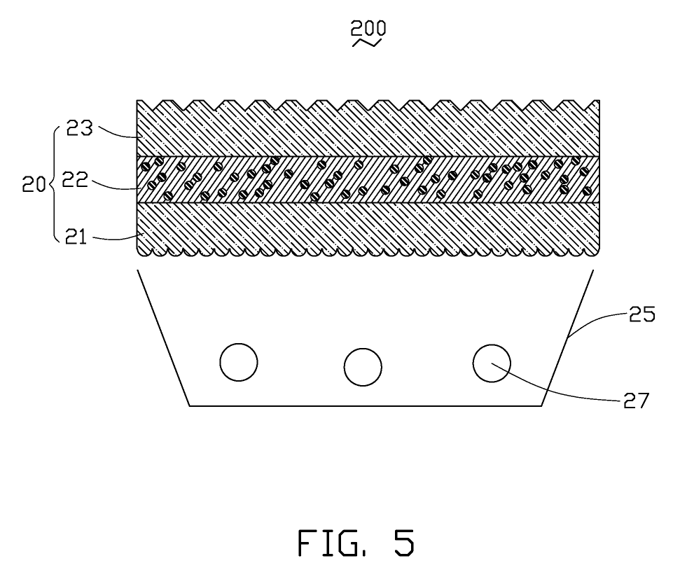

Referring to FIG. 5, a direct type backlight module 200 is shown. The backlight module 200 includes a housing 25, a plurality of lamp tubes 27, and the optical plate 20. The lamp tubes 27 are regularly arranged above a base of the housing 25. The optical plate 20 is positioned on top of the housing 25, with the first transparent layer 21 facing the lamp tubes 27. It should be pointed out that in an alternative embodiment, the second transparent layer 23 of the optical plate 20 may be arranged to face the lamp tubes 27. That is, the optical plate 20 is configured to allow light rays from the lamp tubes 27 to enter the optical plate 20 via either the first transparent layer 21 or the second transparent layer 23.

In the backlight module 200, when the light rays enter the optical plate 20 via the first transparent layer 21, the light rays are diffused by the spherical protrusions 211 of the first transparent layer 21. Then the light rays are substantially further diffused in the light diffusion layer 22 of the optical plate 20. Finally, many or most of the light rays are condensed by the micro protrusions 231 of the second transparent layer 23 before they exit the optical plate 20. As a result, a brightness of the backlight module 200 can be increased. In addition, the light rays are diffused at two levels, so that a uniformity of optical output provided by the optical plate 20 is enhanced. Moreover, the first transparent layer 21, the light diffusion layer 22, and the second transparent layer 23 are integrally formed together (see above), with no air pockets trapped in the respective interfaces therebetween. Thus the efficiency of utilization of light rays is increased. Furthermore, in the backlight module 200, the optical plate 20 in effect replaces the conventional combination of a diffusion plate and a prism sheet. Thereby, a process of assembly of the backlight module 200 is simplified, and an efficiency of assembly is improved. Still further, in general, a volume occupied by the optical plate 20 is less than that occupied by the conventional combination of a diffusion plate and a prism sheet. Thereby, a volume of the backlight module 200 can also be reduced.

In the alternative embodiment, when the light rays enter the optical plate 20 via the second transparent layer 23, the optical uniformity of the optical plate 20 is also enhanced, and the utilization efficiency of light rays is also increased. Nevertheless, the light rays emitted from the optical plate 20 via the first transparent layer 21 are different from the light rays emitted from the optical plate 20 via the second transparent layer 23. For example, when the light rays enter the optical plate 20 via the first transparent layer 21, a viewing angle of a liquid crystal display device using the backlight module 200 is somewhat greater than that of a liquid crystal display device using a backlight module with the light rays entering the optical plate 20 via the second transparent layer 23.

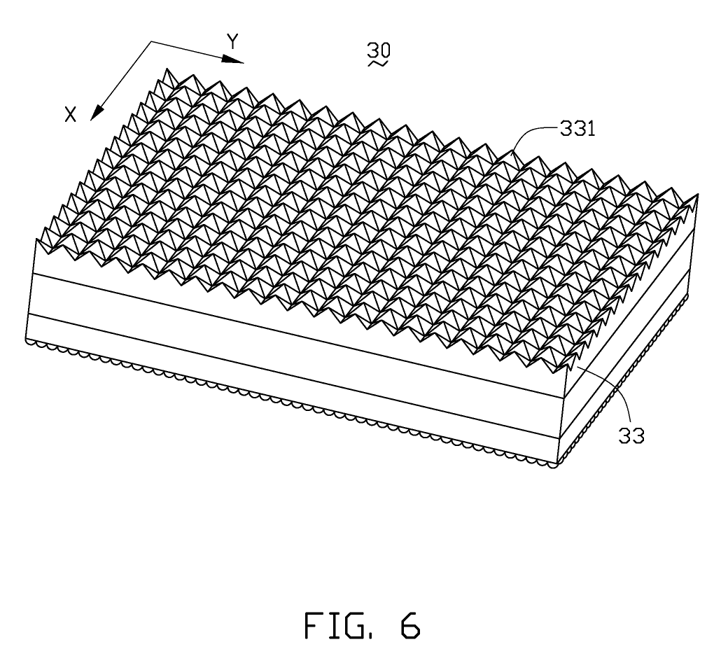

Referring to FIG. 6, an optical plate 30 according to a second embodiment of the present invention is shown. The optical plate 30 is similar in principle to the optical plate 20 of the first embodiment, except that each of micro protrusions 331 of a second transparent layer 33 is a four-sided pyramid. That is, each micro protrusion 331 has four side surfaces. An apex angle defined by two symmetrically opposite side surfaces of the micro protrusion 331 is in the range from about 60 degrees to about 120 degrees, and an apex angle defined by two other symmetrically opposite side surfaces of the micro protrusion 331 is in the range from about 60 degrees to about 120 degrees.

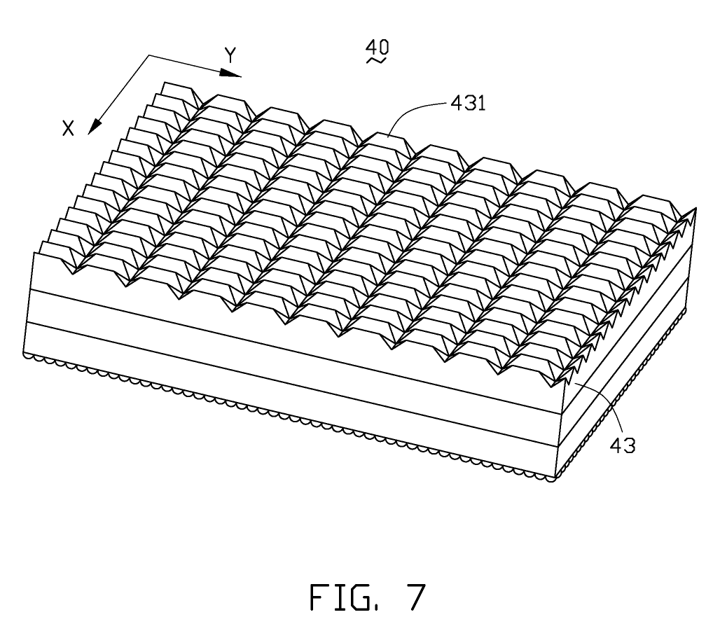

Referring to FIG. 7, an optical plate 40 according to a third embodiment of the present invention is shown. The optical plate 40 is similar in principle to the optical plate 20 of the first embodiment, except that each of micro protrusions 431 of a second transparent layer 43 is a polyhedron that includes four planar side surfaces. Each of a first pair of symmetrically opposite side surfaces of the four side surfaces is an isosceles triangle. The planar surface of each isosceles triangle is parallel to an X-axis, as shown. Each of a second pair of symmetrically opposite side surfaces of the four side surfaces is an isosceles trapezium. The planar surface of each isosceles trapezium is parallel to a Y-axis, as shown. An imaginary angle defined by the first pair of symmetrically opposite side surfaces of each micro protrusion 431 is in the range from about 60 degrees to about 120 degrees, and an apex angle defined by the second pair of symmetrically opposite side surfaces of the micro protrusion 431 is in the range from about 60 degrees to about 120 degrees.

In the above-described embodiments, an interface between the light diffusion layer and the first transparent layer is flat, and an interface between the light diffusion layer and the second transparent layer is flat. Alternatively, the interface between the light diffusion layer and the first transparent layer, and/or the interface between the light diffusion layer and the second transparent layer, may be configured otherwise. That is, either or both of the interfaces can be non-planar.

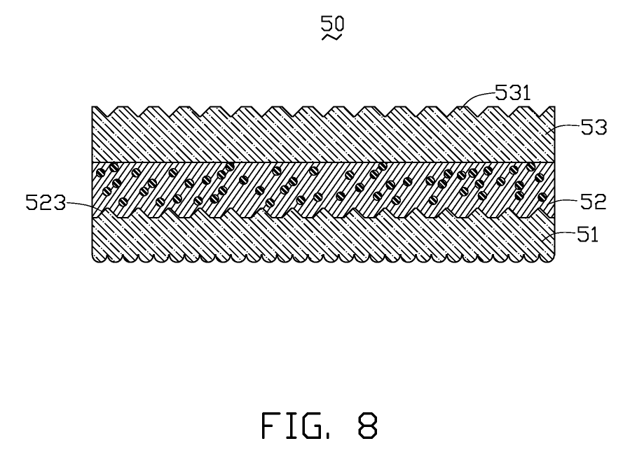

For example, referring to FIG. 8, an optical plate 50 according to a fourth embodiment of the present invention is similar in principle to the optical plate 20 of the first embodiment. However, the optical plate 50 includes a first transparent layer 51, a light diffusion layer 52, and a second transparent layer 53. The light diffusion layer 52 defines a plurality of recesses 523 at an interface (not labeled) between the light diffusion layer 52 and the first transparent layer 51. The recesses 523 are generally frusto-pyramidal shaped. Alternatively, the recesses 523 may for example be hemispherical. Therefore an area of mechanical engagement between the first transparent layer 51 and the light diffusion layer 52 is increased, and a strength of the mechanical engagement between the first transparent layer 51 and the light diffusion layer 52 is correspondingly increased.

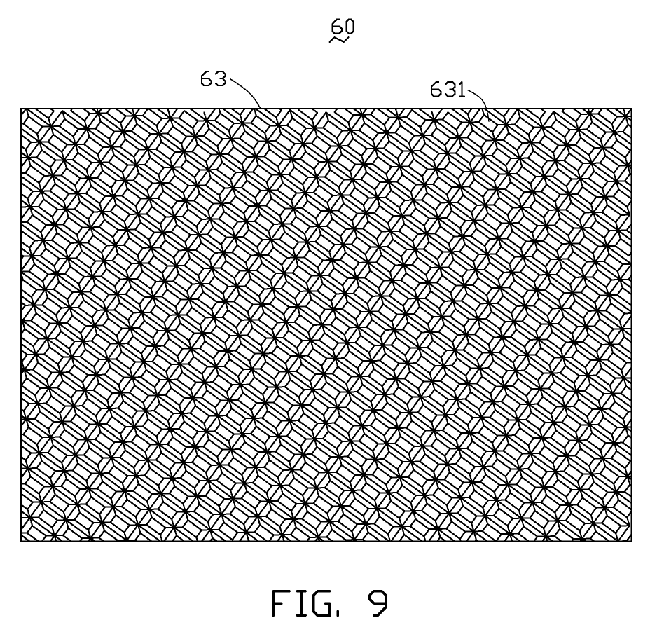

Referring to FIG. 9, an optical plate 60 according to a fifth embodiment of the present invention is shown. The optical plate 60 is similar in principle to the optical plate 20 of the first embodiment. However, the optical plate 60 includes a second transparent layer 63, and the second transparent layer 63 has a plurality of micro protrusions 631. The micro protrusions 631 are arranged in an array of parallel rows, with the rows being oblique (nonparallel) relative to respective of four side edges of the second transparent layer 63. That is, an angle between each of the rows and each of two respective side edges of the second transparent layer 63 is in the range from greater than 0 degrees to less than 90 degrees. In the illustrated embodiment, the rows are aligned with each other in a regular array, with the micro protrusions 631 arranged end-to-end in any line of micro protrusions 631 oriented along a first direction, and the micro protrusions 631 arranged side-by-side in any line of micro protrusions 631 oriented along a second direction that is perpendicular to the first direction.

In alternative embodiments, each of the micro protrusions 231, 331, 531, 631 can instead only include three side surfaces. That is, the micro protrusions 231, 531, 631 may be triangular pyramidal-like frustums, and the micro protrusions 331 may be triangular pyramids. Each of the micro protrusions 231, 331, 431, 531, 631 may instead include five or more side surfaces.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin;
wherein the first transparent layer, the light diffusion layer, and the second transparent layer are integrally molded together, with the first transparent layer in immediate contact with the light diffusion layer, and the second transparent layer in immediate contact with the light diffusion layer such that there are no air or gas pockets trapped between the first transparent layer and the light diffusion layer nor between the second transparent layer and the light diffusion layer, the first transparent layer has a plurality of spherical protrusions at an outer surface thereof that is farthest from the light diffusion layer, and the second transparent layer has a plurality of micro protrusions at an outer surface thereof that is farthest from the light diffusion layer.

2. The optical plate as claimed in claim 1, wherein a thickness of each of the light diffusion layer, the first transparent layer, and the second transparent layer is greater than or equal to 0.35 millimeters.

3. The optical plate as claimed in claim 2, wherein a combined thickness of the light diffusion layer, the first transparent layer, and the second transparent layer is in the range from about 1.05 millimeters to about 6 millimeters.

4. The optical plate as claimed in claim 1, wherein each of the first and second transparent layers is made of material selected from the group consisting of polyacrylic acid, polycarbonate, polystyrene, polymethyl methacrylate, methylmethacrylate and styrene. and any combination thereof.

5. The optical plate as claimed in claim 1, wherein a pitch between two adjacent spherical protrusions is in the range from about 0.025 millimeters to about 1.5 millimeters.

6. The optical plate as claimed in claim 5, wherein a radius of each of the spherical protrusions is in the range from about a quarter of the pitch between two adjacent spherical protrusions to about twice the pitch between two adjacent spherical protrusions, and a height of each spherical protrusion is in the range from about 0.01 millimeters to the radius of the spherical protrusion.

7. The optical plate as claimed in claim 1, wherein the spherical protrusions are arranged regularly on the outer surface of the first transparent layer in a matrix.

8. The optical plate as claimed in claim 1, wherein the micro protrusions are selected from the group consisting of pyramidal-like frustums, four-sided pyramids, and micro protrusions having four side surfaces, and each of said micro protrusions having four side surfaces comprises a first pair of opposite side surfaces parallel to a first direction, said first pair of opposite side surfaces each having the shape of an isosceles triangle, and a second pair of opposite side surfaces parallel to a second direction, said second pair of opposite side surfaces each having the shape of an isosceles trapezium, with the first direction being perpendicular to the second direction.

9. The optical plate as claimed in claim 8, wherein a pitch between two adjacent micro protrusions along the first direction is in the range from about 25 microns to about 1 millimeter, and a pitch between two adjacent micro protrusions along the second direction is in the range from about 25 microns to about 1 millimeter.

10. The optical plate as claimed in claim 8, wherein for each micro protrusion that is a pyramidal-like frustum, an imaginary angle defined by a first pair of opposite side surfaces of the micro protrusion is in the range from about 60 degrees to about 120 degrees, and an imaginary angle defined by a second pair of opposite side surfaces of the micro protrusion is in the range from about 60 degrees to about 120 degrees, for each micro protrusion that is a four-sided pyramid, an angle defined by a first pair of opposite side surfaces of the micro protrusion is in the range from about 60 degrees to about 120 degrees, and an angle defined by a second pair of opposite side surfaces of the micro protrusion is in the range from about 60 degrees to about 120 degrees, and for each of said micro protrusions having four side surfaces, an imaginary angle defined by said first pair of opposite side surfaces of the micro protrusion is in the range from about 60 degrees to about 120 degrees, and an angle defined by said second pair of opposite side surfaces of the micro protrusion is in the range from about 60 degrees to about 120 degrees.

11. (canceled)

12. The optical plate as claimed in claim 1, wherein the micro protrusions are arranged in parallel rows, with each row being oblique relative to an edge of the second transparent layer.

13. The optical plate as claimed in claim 1, wherein at least one of the following interfaces is flat: a common interface between the light diffusion layer and the first transparent layer, and a common interface between the light diffusion layer and the second transparent layer.

14. The optical plate as claimed in claim 1, wherein at least one of the following interfaces is non-planar: a common interface between the light diffusion layer and the first transparent layer, and a common interface between the light diffusion layer and the second transparent layer.

15. The optical plate as claimed in claim 14, wherein the light diffusion layer defines a plurality of frusto-pyramidal shaped recesses at the common interface between the light diffusion layer and the first transparent layer.

16. The optical plate as claimed in claim 1, wherein the transparent matrix resin of the light diffusion layer is made of material selected from the group consisting of polyacrylic acid, polycarbonate, polystyrene, polymethyl methacrylate, methylmethacrylate and styrene (MS), and any combination thereof.

17. The optical plate as claimed in claim 1, wherein the diffusion particles are made of material selected from the group consisting of titanium dioxide, silicon dioxide, acrylic resin, and any combination thereof.

18. An optical plate, comprising:
a first transparent layer;
a second transparent layer; and
a light diffusion layer between the first and second transparent layers, the light diffusion layer being integrally molded together with the first and second transparent layers, with the first transparent layer gaplessly adjoining the light diffusion layer, and the second transparent layer gaplessly adjoining the light diffusion layer such that there are no air or gas pockets trapped between the first transparent layer and the light diffusion layer nor between the second transparent layer and the light diffusion layer, the light diffusion layer comprising a transparent matrix resin and a plurality of diffusion particles dispersed in the transparent matrix resin;
wherein the first transparent layer includes a plurality of spherical protrusions extending from an outer surface thereof farthest from the second transparent layer, and the second transparent layer includes a plurality of micro protrusions on an outer surface thereof farthest from the first transparent layer.

19. A direct type backlight module, comprising:
a housing;
a plurality of light sources disposed on or above a base of the housing; and
an optical plate disposed above the light sources at a top of the housing, the optical plate comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin;
wherein the first transparent layer, the light diffusion layer, and the second transparent layer are integrally molded together with the first transparent layer in immediate contact with the light diffusion layer, and the second transparent layer in immediate contact with the light diffusion layer such that there are no air or gas pockets trapped between the first transparent layer and the light diffusion layer nor between the second transparent layer and the light diffusion layer, the first transparent layer has a plurality of spherical protrusions protruding from an outer surface thereof farthest from the light diffusion layer, and the second transparent layer has a plurality of micro protrusions protruding from an outer surface thereof farthest from the light diffusion layer.

20. The direct type backlight module as claimed in claim 19, wherein a selected one of the first transparent layer and the second transparent layer of the optical plate is arranged to face the light sources, such that light rays from the light sources can enter the optical plate via the selected first transparent layer or second transparent layer.
